(19) United States
(12) Patent Application Publication
(10) Pub. No.: US 2007/0179211 A1
(43) Pub. Date: Aug. 2, 2007

(54) Energy-curable intaglio printing

(75) Inventors: Michael W. Leonard, Kent (GB); John A. Dyer, Kent (GB); Martin J. Thompson, Kent (GB); James R. Tucker, London (GB); Grazyna M. Robinson, Kent (GB)

Correspondence Address: DICKSTEIN SHAPIRO LLP, 1177 AVENUE OF THE AMERICAS 6TH AVENUE, NEW YORK, NY, 10036-2714, US

(73) Assignee: Sun Chemical Corporatin, Parsippany, NJ (US)

(21) Appl. No.: 10/599,537

(22) PCT Filed: Mar. 30, 2005
(86) PCT No.: PCT/US05/10719

§ 371 Date: Mar. 2, 2007

(30) Foreign Application Priority Data
Apr. 1, 2004 (GB) 0407473.8
Sep. 21, 2004 (GB) 0420968.0

(51) Int. Cl. B29C 71/04

(52) U.S. Cl. 522/71

(57) ABSTRACT

The wiping ability of an energy-curable intaglio printing ink is improved by the incorporation therein of a plasticiser

The present invention relates to a novel energy-curable intaglio printing ink, which is especially suitable for printing security documents, including bank notes.

Security documents are preferably printed by the intaglio printing process. The term “intaglio printing” as used in this application refers to the so-called “engraved steel die” or “copper plate” printing processes which are well known to those skilled in the art. The printing plates used herein are usually chromium plated, engraved nickel plates or cylinders, made by galvanic replication of an—often hand-engraved—original copper plate. The following does not apply to the also well known rotogravure or gravure printing processes, which rely on a different type of ink.

In intaglio printing, ink is applied under pressure to the engraved surface of a cylinder. Thus, not only does the ink fill the engravings of the cylinder, it is also applied to the planar non-image surface of the cylinder. It is thus essential that ink is thoroughly wiped from the planar surface of the engraved cylinder before the printing process is carried out. This is commonly effected by a wiping cylinder contra-rotating to the engraved cylinder so that the two surfaces which touch are moving in opposite directions. Given the right conditions and, crucially, the right ink, this will remove the surplus ink from the planar surface as well as a small amount of ink from the surface of the ink in the engravings, so that the only ink on the engraved cylinder is in the engravings. This wiping process is unique to intaglio printing. The substrate to be printed is then passed between the engraved cylinder and an impression material, which is typically another cylinder, with the application of considerable pressure between the engraved cylinder and the impression material, which is a hard but deformable material. The considerable pressure deforms the impression material, forcing the substrate to be printed into the engravings on the engraved cylinder. This results in the substrate picking up some ink, corresponding to the engravings on the surface of the engraved cylinder. The ink then has to be dried. Conventionally, this has been done either by the application of heat or, more commonly, by oxidative drying, which has the substantial disadvantage that it may take more than 48 hours to dry fully. However, in recent years, energy curing, e.g. by ultraviolet or electron beam, has become more common in other printing processes and there is a demand for a similar energy curing process for intaglio printing, since drying is almost immediate.

Because of the unique characteristics of intaglio printing, the inks used for other forms of printing, for example lithographic printing, cannot be used for intaglio, and the formulations tend to be completely different. For example, GB 1466470 discloses an ultraviolet-curable ink for copperplate intaglio printing which comprises specific amounts of a curable binder which is an ester or amide of acrylic acid, a pigment, a photoinitiator, an activator for the photoinitiator and an inert extender permeable to ultraviolet light.

GB1469717 discloses an ultraviolet-curable intaglio printing ink comprising a non-ultraviolet setting adduct of tung oil with an unsaturated carboxylic acid and an ultraviolet setting adduct of tung oil with an unsaturated carboxylic acid.

EP432093B1 discloses an ultraviolet-curable intaglio printing ink comprising specific amounts of a pigment, an energy sensitive cationic polymerisation initiator, a viscous binder composition, a compound capable of being polymerised by cationic polymerisation, and a thermoplastic polymeric material which is not cationically polymerisable.

EP1,260,563 discloses UV intaglio ink formulations which are water-washable and which can easily be precipitated from the wiping solution at the post-wiping stage. The patent does not offer any guidance on how to improve wipeability of the ink from the engraved plate cylinder, and we have found that the formulations in this patent give poor wipeability.

Whilst these prior art documents do disclose inks that may be used for intaglio printing and which are capable of drying by energy curing, they fail to address one crucial matter, namely the ability of the ink to be removed easily from the planar surfaces of the engraved cylinder before printing, without removing the ink within the engravings.

Two methods are currently commonly used to remove surplus ink from the engraved cylinder—paperwipe and waterwipe. In the paperwipe method, crepe paper is applied by means of an oscillating wiper bar under pressure to the surface of the engraved cylinder. The combination of the oscillation of the wiper bar and the rotational movement of the engraved cylinder results in high shear forces being applied to the ink, with the result that surplus ink is adsorbed on the surface and into the folds of the crepe paper and thus effectively removed from the engraved cylinder.

The waterwipe method, sometimes referred to as “cylinderwipe”, uses a cylinder coated with a material to which the ink adheres easily, for example polyvinyl chloride (PVC) to remove the surplus ink from the engraved cylinder. The ink has then to be completely removed from the coated surface of the PVC cylinder before that part of the surface returns to contact with the engraved cylinder. This is achieved by a combination of scraping, brushing and washing in an aqueous alkaline bath.

Plainly, the rheology of the ink is critical to its success. In achieving a satisfactory rheology, heat-set inks have an advantage over energy-cured inks, since they can be diluted to achieve a desired viscosity using an organic solvent, which is then removed during the heat-setting process. Energy-curable intaglio inks do not have this advantage and, as a result, tend to be tackier than heat-set inks.

In addition to the rheology and ease of removal of surplus ink, discussed above, intaglio printing inks must meet the following requirements:
They must remain on the engraved cylinder until the moment of printing when they must transfer readily and in a consistent manner to the substrate to be printed.
They must have good film-forming properties and the cured inks must be sufficiently flexible that they remain intact even when the printed matter (e.g. banknotes) is subject to abuse.
Once the substrate has been printed, the ink must not transfer back to other surfaces with which it may come into contact, especially other printed matter.
The cured ink must have excellent chemical and mechanical resistance so as to withstand the many diverse materials and conditions to which banknotes may be subject.
They must be safe for handling by all members of the public, including the very young.
It is also self-evident that, where the ink is to be cured by energy, e.g. ultraviolet or electron beam, any components added to the ink to achieve any of the above requirements must not interfere with the cure. Not surprisingly, it is difficult to meet all of these desiderata simultaneously.

We have now surprisingly discovered that the incorporation into a conventional ultraviolet-curable intaglio printing ink of any of the well known class of plasticisers will improve the wiping ability of the ink, in both the waterwipe and the paperwipe methods, without any adverse impact on any of the requirements mentioned above.

Thus, the present invention consists in an energy-curable intaglio printing ink comprising a pigment, an energy-curable binder composition, a photoinitiator and a plasticiser.

The term “plasticiser” is used herein to mean a material which is capable of solvating a film-forming polymer, and which does not substantially evaporate during the process of drying the ink. Materials which serve as plasticisers are well known in the industry. Although the primary function of the plasticiser in the inks of the present invention is not to solvate, and hence plasticise, a polymer, it is possible that they do serve this function in the cured ink, thus enhancing its desirable properties. Instead, we have surprisingly found that the inclusion of the plasticiser enhances the wiping ability of the ink, which is a property of the ink which manifests before the ink is cured. Thus, its function in the compositions of the present invention is as a wiping aid.

The plasticiser used should be non-carcinogenic and should be generally recognised as safe to be handled by humans. Preferably, it is a food grade compound.

Plasticisers tend to be low molecular weight materials. We particularly prefer that the plasticiser should have a molecular weight of from 100 to 500, more preferably from 150 to 350.

We also particularly prefer that the plasticiser should have a boiling point at STP of from 100 to 500° C., more preferably from 150 to 350° C.

In general, the plasticisers used in the present invention do not polymerise into the final dried ink. Whilst it would be desirable if they did polymerise into the ink, since this would eliminate the possibility of them leaching out, in practice, we have found that those plasticisers which are capable of polymerisation are less effective in enhancing the wiping ability of the ink.

Examples of suitable plasticisers include:

Abietates, for example: hydroabietyl abietate, hydrogenated methyl abietate, methyl abietate;

Acetates, for example: glyceryl diacetate, glyceryl triacetate, and triethylene glycol diacetate;

Adipates, for example: adipic acid 1,2-propanediol polyester, adipic acid 1,3-butylene glycol polyester, adipic acid benzyl octyl ester, adipic acid benzyl-2-ethylhexyl ester, adipic acid butanediol polyester, di-2-ethylhexyl adipate, dibutyl adipate, diethyl adipate, diisobutyl adipate, diisodecyl adipate, diisononyl adipate, dimethyl adipate, di-n-C7-C9 adipate, dioctyl adipate, adipic acid n-octyl n-decyl ester, adipic acid polyethylene glycol ester and adipic acid polypropylene glycol ester;

Azelates, for example: di-2-ethylhexyl azelate, dihexyl azelate and dioctyl azelate;

Benzoates, for example: butyl benzoate, benzoic acid diethylene glycol ester, benzoic acid dipropylene glycol ester, glyceryl tribenzoate, neopentylglycol dibenzoate, polyethylene glycol 200 dibenzoate, polyethylene glycol 400 dibenzoate, pentaerythritol tetrabenzoate, 2-ethylhexyl p-oxybenzoate, benzoic acid sucrose ester, and triethylene glycol dibenzoate;

Butyrates, for example: glyceryl tributyrate, 2,2,4-trimethyl-1,3-pentanediol diisobutyrate, and 2,2,4-trimethyl-1,3-pentanediol mono(2-methylpropionate);

Caprylates, for example: di(triethylene glycol dioctanoate) caprylate;

Citrates, for example: acetyl tri(2-ethylhexyl) citrate, acetyl tributyl citrate, acetyl triethyl citrate, tributyl citrate, tricyclohexyl citrate, triethyl citrate, and triisoamyl citrate;

Epoxidised oils, fatty acids and esters thereof, for example: 2-ethylhexyl esters of epoxidised tall oil, epoxidised linseed oil, epoxidised soya fatty acid ethylhexyl ester, epoxidised soybean oil;

Fatty acids, which may be saturated or unsaturated, especially those having a molecular weight within the preferred range given above, for example hexanoic, octanoic, decanoic, lauric acid, myristic acid, palmitic acid, stearic acid, arachidic acid, behenic acid, lignoceric acid, lauroleic acid (dodecenoic acid), pentadecanoic acid, margaric acid, myristoleic acid, palmitoleic acid, oleic acid, gadoleic acid (eicosenoic acid), erucic acid, ricinoleic acid, linoleic acid, linolenic acid, licanic acid, eleostearic acid (octadec-9,11,13-trienoic acid), octadecatetraenoic acid, and octadecatraenoic acid;

Combinations of these fatty acids, especially mixtures found in nature, such a linseed oil fatty acid or tall oil fatty acid;

Metal salts of carboxylic acids, such as calcium stearate, lead stearate, zinc stearate, magnesium stearate, calcium ricinoleate and zinc carboxylates;

Esters of fatty alcohols and fatty acids, fatty acid esters of monohydric and polyhydric alcohols (e.g. fatty acid glycerides), esters of fatty acid and amino alcohols, amides or amide esters of, for example, oleic acid and amine alcohols (e.g. ethanolamine), urethanes of fatty acid partial esters of polyhydric alcohols and polyisocyanates, and esters of alcohols and amine acids amidated with fatty acids;

Salts of fatty amines such as octylamine, oleoylamine, dodecylamine;

Salts of amines obtainable by reduction of fatty acid amides or basic amine derivatives obtainable by alkoxylation from ammonia or primary and secondary aliphatic or aromatic amines; salts of fatty acid esters of such alkoxylation products (e.g. N,N-dimethylethanolamine, N-methyldiethanolamine or tetraethoxy or tetrapropoxy ethylene);

Salts of amidoamines, such as amidoamines of fatty acids and N-methyldiethylenetriamine or N,N-dimethylethylenediamine or triethylenetetramine and salts of oleic acid or tall oil fatty acids, train oil fatty acid and other fatty acids. (e.g. ethylenebis(stearamide), or oleyl palmitate);

Fumarates, for example dibutyl fumarate;

Glutarates, for example dimethyl glutarate;

Hexanoates, for example: polyethylene glycol 200 di-2-ethylhexyl hexanoate, polyethylene glycol 400 di-2-ethylhexanoate, and polyethylene glycol di-(2-ethylhexanoate);

Lactates, for example: ethyl lactate, isopropyl lactate, and n-butyl lactate;

Laurates, for example: polyethylene glycol 200 monolaurate, polyethylene glycol 400 dilaurate, polyethylene glycol 400 monolaurate, and polyoxyethylene laurate;

Maleates, for example: dibutyl maleate, diisobutyl maleate, diisooctyl maleate, and dioctyl maleate;

Oleates, for example: diglyceryl oleate, epoxidised octyl oleate, monoglyceryl oleate, n-butyl oleate, n-heptyl oleate, oleic acid polyethylene glycol 200, 400 and 600 esters, oleic acid polyethylene glycol diester, oleic acid polyethylene glycol monoester, oleic acid sorbitol ester, tetrahydrofurfiryl ester, oleic acid tetra-sorbitol ester, oleic acid tri-glycerol ester, and oleic acid tri-sorbitol ester;

Palmitates, for example: cetyl palmitate and palmitic acid polyethylene glycol monoester;

Phosphates, such as diphenyl 2-ethylhexyl phosphate, diphenyl isodecyl phosphate, diphenyl octyl phosphate, tri(2-ethylhexyl) phosphate, tributoxyethyl phosphate, tributyl phosphate, triethyl phosphate, trioctyl phosphate, and triphenyl phosphate;

Phthalates, for example: butyl phthalyl butyl glycolate, ethyl phthalyl ethyl glycolate, benzyl phthalate, benzyl butyl phthalate, benzyl octyl phthalate, butyl phthalate, methyl phthalate, carboxybutyl phthalate, butyl octyl phthalate, 2-ethylhexyl phthalate, dicyclohexyl phthalate, didecyl phthalate, diethyl phthalate, diheptyl phthalate, diheptyl nonyl phthalate, dihexyl phthalate, diisobutyl phthalate, diisodecyl phthalate, diisoheptyl phthalate, diisononyl phthalate, diisooctyl phthalate, diisotridecyl phthalate, dimethoxyethyl phthalate, dimethyl phthalate, dimethylcyclohexyl phthalate, phthalic acid C6-C10 ester, phthalic acid C7-C11 ester, phthalic acid C8-C10 ester, phthalic acid C8-C12 ester, phthalic acid C9-C11 ester, dibutyl phthalate, phthalic acid C10-C12 ester, dioctyl phthalate, diphenyl phthalate, di-tridecyl phthalate, di-undecyl phthalate, heptyl phthalate, nonyl phthalate, undecyl phthalate, hexyl phthalate, octyl phthalate, and decyl phthalate;

Polyol esters, for example polyethylene glycol 400, polypropylene glycol hexamethylene diisocyanate copolymer, polypropylene glycol, and polypropylene glycol tolylene diisocyanate copolymer;

Ricinoleates, for example butyl acetyl ricinoleate, butyl ricinoleate, ethylene glycol ricinoleate, glyceryl monoricinoleate, glyceryl tri(acetyl ricinoleate), glyceryl triricinoleate, methyl acetyl ricinoleate, methyl ricinoleate, polyethylene glycol monoricinoleate, and propylene glycol monoricinoleate;

Sebacates, for example: sebacic acid 1,2-propanediol polyester, di-2-ethylhexy sebacate, dibutyl sebacate, and dioctyl sebacate;

Stearates, for example: 12-hydroxystearic acid, glyceryl tri(12-hydroxystearate), isobutyl stearate, butyl stearate, stearic acid octyl epoxy ester, and stearic acid polyethylene glycol 400 diester;

Tall oil esters, for example: hexyl tallate, 2-ethylhexyl tallate, isooctyl tallate, and octyl epoxy tallate;

Other esters, for example: diethylene glycol dipelargonate, diethyl hexanedioic acid, dimethyl hexanedioic acid, linseed oil maleinate, methyl phthalyl ethyl glycolate, polyethylene glycol ester of castor oil, dilauryl thiodipropionate, dimethyl succinate, and sucrose aceto isobutyrate;

Sulphonamides, for example: N-butyl sulphonamide, butyl benzyl sulphonamide, cyclohexyl p-toluenesulphonamide, toluenesulphonamide-formaldehyde condensation product, o-ethyl-p-toluenesulphonamide, N-butyl-p-toluenesulphonamide, N-cyclohexyl-p-toluenesulphonamide, N-ethyl-o-toluenesulphonamide, N-ethyl-o,p-toluenedisulphonamide, N-ethyl-p-toluenesulphonamide, o-toluenesulphonamide, o,p-toluenedisulphonamnide, and p-toluenesulphonamide;

Aliphatic hydrocarbon solvents with boiling points above 150° C. These are typically derived from fractionation of petroleum, and are described in the Printing Ink Manual, 5th edition, edited by R H Leach and others, published by Chapman & Hall in 1993, at pages 253-254. An example is Exxsol D 120 (sold by ExxonMobil) with a boiling range of 255-300° C.; and

Others, for example: butylurethane-fornaldehyde copolymer, butyl carbamate, hydrogenated castor oil, di(phenoxyethyl) formal, diethyldiphenylurea, ethoxylated glycerol, ethoxylated fatty alcohol, formaldehyde-urea copolymer, ethoxylated glycerol, and polyethylene glycol monobutyl ether.

Of these, we particularly prefer the sebacates, citrates, fatty acids (particularly naturally occurring mixtures of fatty acids) and fatty acid esters. Of the fatty acids, the most preferred are linseed oil fatty acid, tall oil fatty acid and oleic acid.

The plasticiser or wiping aid is preferably incorporated into the ink at a level of from 0.5% to 10%, more preferably from 3 to 5%, by weight of the finished ink.

The printing inks of the present invention are designed to be energy-cured inks, e.g. cured by UV or EB (electron beam) radiation, and typically include a binder comprising one or more oligomers and/or reactive monomers. Formulations are well-known and can be found in standard textbooks such as the series “Chemistry & Technology of UV & EB Formulation for Coatings, Inks & Paints”, published in 7 volumes in 1997-1998 by John Wiley & Sons in association with SITA Technology Limited.

Suitable oligomers (also referred to as prepolymers) include epoxy acrylates, acrylated oils, urethane acrylates, polyester acrylates, silicone acrylates, acrylated amines, acrylic saturated resins and acrylic acrylates. Further details and examples are given in “Chemistry & Technology of UV & EB Formulation for Coatings, Inks & Paints”, Volume II: Prepolymers & Reactive Diluents, edited by G Webster.

Because of the high viscosity of most oligomers, diluents are often required to reduce the overall viscosity of the energy curing ink or coating formulation, so as to assist in handling and application. Diluents may include ordinary organic solvents, water, or “reactive” monomers which are incorporated into the cured film. Reactive monomers are typically acrylates or methacrylates, and can be monofunctional or multifunctional. Examples of multifunctional monomers would include polyester acrylates or methacrylates, polyol acrylates or methacrylates, and polyether acrylates or methacrylates. Further details and examples are given in the book edited by G Webster (op. cit.).

In the case of inks to be cured by UV radiation, it is usually necessary to include one or more photoinitiators to initiate the curing reaction of the oligomers and reactive monomers.

The photoinitiators may be classified into two groups; one is an intramolecular-bond-cleavage type and the other is an intramolecular-hydrogen-abstraction type.

Examples of the intramolecular-bond-cleavage type photoinitiators include, for example, acetophenones such as diethoxyacetophenone, 2-hydroxy-2-methyl-1 -phenylpropane- 1-one, benzyldimethylketal, 1-(4-isopropylphenyl)-2-hydroxy-2-methylpropan-1-one, 4-(2-hydroxylethoxy) phenyl-(2-hydroxy-2-methylpropyl)ketone, 4-(2-hydroxyethoxy)phenyl-(2-hydroxy-2-propyl)ketone, 1-hydroxycyclohexyl-phenylketone, 2-methyl-2-morpholino(4-thiomethylphenyl)propan- 1-one, and 2-benzyl-2-dimethylamino-1-(4-morpholinophenyl)-butanone; benzoins such as benzoin, benzoinmethyl ether, benzoinisopropyl ether; acylphosphine oxides such as 2,4,6-trimethylbenzo-indiphenylphosphine oxides; benzyl and methylphenyl-glyoxyester.

Examples of intramolecular-hydrogen-abstraction type photoinitiators include, for example, benzophenones such as benzophenone, methyl-4-phenylbenzophenone o-benzoylbenzoate, 4,4′-dichlorobenzophenone, hydroxybenzophenone, 4-benzoyl-4′-methyl-diphenylsulfide, acrylic-benzophenone, 3,3 ′, 4,4′-tetra(t-butylperoxycarbonyl)benzophenone, 3,3′-dimethyl-4-methoxybenzophenone; thioxanthones such as 2-isopropyl-thioxanthone, 2,4-dimethylthioxanthone, 2,4-diethyl-thioxanthone, 2,4-dichlorothioxanthone; aminobenzophenones such as Michler's ketone, 4,4′-diethylaminobenzophenone; 10-butyl-2-chloroacridone, 2-ethylanthraquinone, 9,10-phenanthrenequinone, and camphorquinone.

Further examples of photoinitiators can be found in standard textbooks such as “Chemistry & Technology of UV & EB Formulation for Coatings, Inks & Paints”, Volume III, “Photoinitiators for Free Radical Cationic and Anionic Polymerisation”, 2^{nd} edition, by J. V. Crivello & K. Dietliker, edited by G. Bradley and published in 1998 by John Wiley & Sons in association with SITA Technology Limited.

It may also be advantageous to use a sensitiser in conjunction with the photoinitiator in order to achieve efficient curing.

To make inks suitable for the water wipe intaglio presses, the ink must be soluble in dilute caustic solutions. This can be achieved by using acid fimctional resins. These may be acrylate or methacrylate functional, and therefore reactive, or inert in UV and EB systems. Suitable examples include styrene maleic anhydride resins, such as SMA1440F available from Cray Valley, and aromatic acid methacrylate and acrylate half esters.

The inks will contain one or more pigments as the colouring agent. The pigment may be any desired inorganic and/or organic pigment suitable for intaglio printing such as CI Pigment Yellow 12, CI Pigment Yellow 42, CI Pigment Yellow 93, CI Pigment Yellow 110, CI Pigment Yellow 173, CI Pigment Black 7, CI Pigment Black 11, CI Pigment Orange 34, CI Pigment Red 9, CI Pigment Red 22, CI Pigment Red 23, CI Pigment Red 57:1, CI Pigment Red 67, CI Pigment Red 122, CI Pigment Red 146, CI Pigment Red 185, CI Pigment Red 224, CI Pigment Red 242, CI Pigment Red 254, CI Pigment Green 7, CI Pigment Green 36, CI Pigment Blue 15, CI Pigment Blue 15:3, CI Pigment Violet 23, CI Pigment Violet 32, or CI Pigment Violet 37.

Preferably, the ink will contain one or more fillers (also called extenders) in an amount of about 1-35% based on the weight of the finished ink. Suitable fillers include china clay, calcium carbonate, calcium sulphate, talc, silica, corn starch, titanium dioxide, alumina and mixtures thereof.

The ink may also contain about 1 to 5%, based on the weight of the finished ink, of a wax to improve scuff resistance. Suitable waxes include camauba waxes, montan waxes, polytetrafluoroethylene waxes, polyethylene waxes, Fischer-Tropsch waxes, silicone fluids and mixtures thereof.

Other additives may be incorporated in the ink, including adhesive reagents, antifoaming reagents, levelling reagents, flow reagents, antioxidants, ultraviolet absorbers, flame retardants, etc.

The viscosity of the inks measured at 26° C. and a shear rate of 100 sec⁻¹ is preferred to be in the range 20-200 Pascal seconds, more preferably 50-125 Pascal seconds (Pas).

The inks of the present invention can be used on standard intaglio presses fitted with UV lamps and with a plate temperature of 40° C. The curing conditions for UV inks are well known in the art.

The invention is further illustrated by the following non-limiting Examples. Percentages are by weight.

### EXAMPLES 1-3 & COMPARATIVE EXAMPLE 1

Waterwipe ink

The first three ingredients shown below in Table 1 were mixed together using a Silverson high speed stirrer for approximately 30 minutes until a clear amber varnish was produced. The other ingredients were then added to this mixture and mixed to form a paste. The paste was then fully mixed and dispersed using a three roll mill to produce a homogeneous paste ink.

TABLE 1

| Material | % | Supplier |
|---|---|---|
| Ebecryl 657 | 30 | UCB chemicals |
| SMA1440F | 10 | Cray Valley |
| Sartomer SR494 | 16 | Cray Valley |
| Chromophtal LGLD | 5 | CIBA |
| Esacure ITX | 3.0 | Lamberti |
| Irgacure 369 | 2.4 | Ciba Geigy |
| Lucirin TPO | 0.9 | BASF |
| Microtalc IT extra | 17.7 | Omya |
| Carnauba Wax | 3 | Eggar |
| Empilan CDE | 4 | Huntsman |
| Turkey Red Oil | 2 | J & W Whewell |
| Wiping Aid | 5 | Various |
| Florstab UV-1 | 1 | Kromachem |
| Total | 100 | |

The wiping aids (plasticisers) used were dibutyl sebacate (Example 1), acetyl triethyl citrate (Example 2), and tall oil fatty acid (TOFA) (Example 3). In Comparative Example 1, additional Sartomer SR494 was used in place of a wiping aid.

The viscosity data for these Examples is shown in the following Table 2.

TABLE 2

| | | | |
|---|---|---|---|
| Shear rate 1/s | | 2 | 100 |
| Viscosity Pas | Example 1 | 753.5 | 101.8 |
| at 26° C. | | | |
| | Comparative | 1139.1 | 128.8 |
| | Example 1 | | |
| | Example 2 | 949.4 | 136.1 |
| | Example 3 | 381.2 | 114.8 |

### EXAMPLE 4

Paperwipe ink

The first three ingredients shown below in Table 3 were mixed together using a Silverson high speed stirrer for approximately 30 minutes until a clear amber varnish was produced. The other ingredients were then added to this mixture and mixed to form a paste. The paste was then fully mixed and dispersed using a three roll mill to produce a homogeneous paste ink. In this and the following Examples, the plasticiser (wiping aid) is indicated in the Table by a †.

TABLE 3

| | % | Supplier |
|---|---|---|
| Ebecryl 648 | 55 | UCB chemicals |
| OTA 480 | 3 | UCB chemicals |
| Chromophtal LGLD | 5 | CIBA |
| Microtalc IT extra | 19.7 | Omya |
| Corn Starch | 2 | Cerestar |
| Carnauba wax | 3 | Eggar |
| † Linseed oil | 5 | Akzo Nobel |
| fatty acid | | |
| Esacure ITX | 3 | Lamberti |
| Lucirin TPO | 0.9 | BASF |
| Irgacure 369 | 2.4 | Ciba |
| Florstab UV-1 | 1 | Kromachem |
| Total | 100 | |

### EXAMPLE 5

Paperwipe ink

The ingredients of the ink, as shown below in Table 4 were weighed and mixed to form a paste. The paste was then fully mixed and dispersed using a three roll mill to produce a homogeneous, viscous paste ink.

TABLE 4

| | % | Supplier |
|---|---|---|
| Ebecryl 648 | 55 | UCB chemicals |
| OTA 480 | 3 | UCB chemicals |
| Chromophtal LGLD | 5 | CIBA |
| Microtalc IT extra | 19.7 | Omya |
| Corn Starch | 2 | Cerestar |
| Carnauba wax | 3 | Eggar |
| † Lauric acid | 5 | Aldrich chemical |
| Esacure ITX | 3 | Lamberti |
| Lucirin TPO | 0.9 | BASF |
| Irgacure 369 | 2.4 | Ciba |
| Florstab UV-1 | 1 | Kromachem |
| Total | 100 | |

### EXAMPLE 6

Paperwipe ink

The ingredients of the ink, as shown below in Table 5 were weighed and mixed to form a paste. The paste was then fully mixed and dispersed using a three roll mill to produce a homogeneous, viscous paste ink.

TABLE 5

| | % | Supplier |
|---|---|---|
| Ebecryl 648 | 55 | UCB chemicals |
| OTA 480 | 3 | UCB chemicals |
| Chromophtal LGLD | 5 | CIBA |
| Microtalc IT extra | 21.7 | Omya |
| Corn Starch | 2 | Cerestar |
| Carnauba wax | 3 | Eggar |
| † Butyl stearate | 3 | Aldrich chemical |
| Esacure ITX | 3 | Lamberti |
| Lucirin TPO | 0.9 | BASF |
| Irgacure 369 | 2.4 | Ciba |
| Florstab UV-1 | 1 | Kromachem |
| Total | 100 | |

### EXAMPLE 7

Waterwipe ink

The ingredients of the ink, as shown below in Table 6 were weighed and mixed to form a paste. The paste was then fully mixed and dispersed using a three roll mill to produce a homogeneous, viscous paste ink.

TABLE 6

| | % | Supplier |
|---|---|---|
| Ebecryl 657 | 30 | UCB chemicals |
| SMA1440F | 10 | Cray Valley |
| OTA 480 | 15 | UCB chemicals |
| Chromophtal LGLD | 5 | Ciba |
| Irgacure 369 | 2.4 | Ciba |
| ITX | 3 | Lamberti |
| Lucirin TPO | 0.9 | BASF |
| Microtalc IT extra | 18.7 | Omya |
| Carnauba Wax | 3 | Eggar |
| Empilan CDE | 4 | Huntsman |
| Turkey Red Oil | 2 | J & W Whewell |
| † Oleic acid | 5 | Aldrich Chemical |
| Florstab UV-1 | 1 | Kromachem |
| Total | 100 | |

### EXAMPLE 8

Waterwipe ink

The first three ingredients shown below in Table 7 were mixed together using a Silverson high speed stirrer for approximately 30 minutes until a clear amber varnish was produced. The other ingredients were then added to this mixture and mixed to form a paste. The paste was then fully mixed and dispersed using a three roll mill to produce a homogeneous paste ink.

TABLE 7

| | % | Supplier |
|---|---|---|
| Ebecryl 657 | 30 | UCB chemicals |
| SMA1440F | 10 | Cray Valley |
| OTA 480 | 15 | UCB chemicals |
| Chromophtal LGLD | 5 | CIBA |
| Irgacure 819 | 2.4 | Ciba |
| ITX | 3 | Lamberti |
| Lucirin TPO | 0.9 | BASF |
| Talc D2002 | 18.7 | Omya |
| Carnauba Wax | 3 | Eggar |
| Empilan CDE | 4 | Huntsman |
| Turkey Red Oil | 2 | J & W Whewell |
| † Hexyl Tallate | 5 | Sun Chemical |
| Florstab UV-1 | 1 | Kromachem |
| Total | 100 | |

The viscosity data for a fresh ink sample is shown in the following Table 8.

TABLE 8

| | | |
|---|---|---|
| Shear rate 1/s | 2 | 100 |
| Viscosity Pas at 26° C. | 669.8 | 112.9 |

### EXAMPLE 9

Waterwipe ink

The first three ingredients shown below in Table 9 were mixed together using a Silverson high speed stirrer for approximately 30 minutes until a clear amber varnish was produced. The other ingredients were then added to this mixture and mixed to form a paste. The paste was then fully mixed and dispersed using a three roll mill to produce a homogeneous paste waterwipe ink.

TABLE 9

| | Amount | |
|---|---|---|
| Material | (wt %) | Supplier |
| Ebecryl 657 (polyester acrylate) | 30 | UCB chemicals |
| SMA1440F (acidic acrylate resin) | 10 | Cray Valley |
| Sartomer 494 (ethoxylated | 17 | Cray Valley |
| pentaerythritol tetraacrylate) | | |
| Chromophtal LGLD (blue pigment) | 5 | CIBA |
| Irgacure 819 (photoinitiator) | 4.9 | CIBA |
| Microtalc IT extra | 20.1 | Omya |
| Carnauba Wax | 3 | Eggar |
| Empilan CDE (Coconut | 4 | Huntsman |
| diethanolamide-surfactant) | | |
| Turkey Red Oil (sulphonated | 2 | J & W Whewell |
| caster oil) | | |
| † Dibutyl sebacate | 3 | Edenol DBS Cognis |
| Florstab UV-1 (UV stabiliser) | 1 | Kromachem |
| Total | 100 | |

The viscosity data for a fresh ink sample is shown in the following Table 10.

TABLE 10

| | | |
|---|---|---|
| Shear rate 1/s | 2 | 100 |
| Viscosity Pas at 26° C. | 798.5 | 120.0 |

### EXAMPLE 10

Paperwipe ink

The ingredients of the ink, as shown below in Table 11 were weighed and mixed to form a paste. The paste was then fully mixed and dispersed using a three roll mill to produce a homogeneous, viscous paste paperwipe ink.

TABLE 11

| | Amount | |
|---|---|---|
| Material | (wt %) | Supplier |
| Ebecryl 648 (epoxy acrylate) | 55 | UCB chemicals |
| Sartomer 494 (ethoxylated | 3 | Cray Valley |
| pentaerythritol tetraacrylate) | | |
| Chromophtal LGLD (blue pigment) | 5 | CIBA |
| Microtalc IT extra | 23.1 | Omya |
| Corn Starch | 2 | Cerestar |
| Carnauba wax | 3 | Eggar |
| † Dibutyl sebacate | 3 | Edenol DBS Cognis |
| Irgacure 819 (photoinitiator) | 4.9 | CIBA |
| Florstab UV-1 (UV stabiliser) | 1 | Kromachem |
| Total | 100 | |

A UV ink was applied to an intaglio plate, and wiped by hand using crepe paper. A print was taken from the wiped plate and the amount of ink left in the planar non-image area was assessed visually. The addition of a plasticiser provided a clean print in that there was no ink in the planar non-image and was a considerable improvement over UV intaglio inks without the addition of plasticiser.

### EXAMPLE 11

Waterwipe ink

The first three ingredients shown below in Table 12 were mixed together using a Silverson high speed stirrer for approximately 30 minutes until a clear amber varnish was produced. The other ingredients were then added to this mixture and mixed to form a paste. The paste was then fully mixed and dispersed using a three roll mill to produce a homogeneous paste waterwipe ink.

TABLE 12

| | Amount | |
|---|---|---|
| Material | (wt %) | Supplier |
| Ebecryl 657 | 30 | UCB chemicals |
| SMA1440F | 10 | Cray Valley |
| Sartomer SR494 | 17 | Cray Valley |
| Microtalc | 20.1 | Omya |
| Irgalite Blue LGLD | 5 | Ciba Geigy |
| Irgacure 819 | 4.9 | Ciba Geigy |
| Carnauba wax | 3 | Eggar |
| Florstab UV1 | 1 | Kromachem |
| † Tall oil fatty acid | 9 | Various |

The viscosity data is shown in the following Table 13.

TABLE 13

| | | |
|---|---|---|
| Shear rate 1/s | 2 | 100 |
| Viscosity Pas at 26° C. | 170.1 | 50.9 |

### EXAMPLE 12

Waterwipe ink

The first three ingredients shown below in Table 14 were mixed together using a Silverson high speed stirrer for approximately 30 minutes until a clear amber varnish was produced. The other ingredients were then added to this mixture and mixed to form a paste. The paste was then fully mixed and dispersed using a three roll mill to produce a homogeneous paste waterwipe ink.

TABLE 14

| | Amount | |
|---|---|---|
| Material | (wt %) | Supplier |
| Ebecryl 657 | 30 | UCB chemicals |
| SMA1440F | 10 | Cray Valley |
| Sartomer SR494 | 17 | Cray Valley |
| Microtalc | 20.1 | Omya |
| Irgalite Blue LGLD | 5 | Ciba Geigy |
| Lucirin TPO | 4.9 | Ciba Geigy |
| Carnauba wax | 3 | Eggar |
| Florstab UV1 | 1 | Kromachem |
| † Tall oil fatty acid | 9 | Various |

The viscosity data is shown in the following Table 15.

TABLE 15

| | | |
|---|---|---|
| Shear rate 1/s | 2 | 100 |
| Viscosity Pas at 26° C. | 190.4 | 52.4 |

### EXAMPLE 13

Paperwipe ink

All the ingredients shown below in Table 16 were added together and mixed to form a paste. The paste was then fully mixed and dispersed using a three roll mill to produce a homogeneous paste paperwipe ink.

TABLE 16

| | | |
|---|---|---|
| CN104 | 38.5 | Cray valley |
| Sartomer SR494 | 19.5 | Cray Valley |
| Microtalc | 22.6 | Omya |
| Irgalite Blue LGLD | 5.5 | Ciba Geigy |
| Lucirin TPO | 2.4 | Ciba Geigy |
| Irgacure 819 | 2.5 | Ciba Geigy |
| Carnauba wax | 3 | Shamrock |
| Florstab UV1 | 1 | Kromachem |
| † Tall oil fatty acid | 5 | Various |

The viscosity data is shown in the following Table 17.

TABLE 17

| | | |
|---|---|---|
| Shear rate 1/s | 2 | 100 |
| Viscosity Pas at 26° C. | 653.1 | 54.5 |

### EXAMPLE 14

Test of wiping and cure

Wiping and printability of the inks were assessed by printing on a proof press I311P manufactured by Komori Currency Technology. The inks were placed in the duct of the press and the printability was assessed by examining the wiping ability, the ink transference from schablone to the printing plate and the quality of the print. The wiping ability was judged by the cleanliness of the non-image area of the print. The transference of the ink was judged by the amount of ink that was transferred to the paper. The plate temperature of the press was set at 35° C. The inks tested were those of Examples 1-3 and Comparative Example 1. The results were judged subjectively by the experienced operator.

All inks were acceptable for their wiping ability but two of them showed superior results: the ink containing citrate (Example 2) and the one containing TOFA (Example 3). These two inks, apart from good wiping, showed better tolerance to small changes in the inking conditions and were more user-friendly. Additionally, the ink containing TOFA transferred better than any other ink.

The control (Comparative Example 1) did not have good flow and did not transfer well. This was the worst ink according to the operator.

The inks were subsequently cured using a medium pressure mercury lamp of 300W/inch power at a belt speed of 70 m/min. The inks all showed excellent cure after one pass under the lamp.

1. An energy-curable intaglio printing ink comprising a pigment, an energy-curable binder composition, a photoinitiator and a plasticiser.

2. A printing ink according to claim 1, wherein the plasticiser is food grade.

3. A printing ink according to claim 1, wherein the plasticiser has a molecular weight of from 100 to 500.

4. A printing ink according to claim 3, wherein said molecular weight is from 150 to 350.

5. A printing ink according to claim 1, wherein the plasticiser has a boiling point of from 100 to 500° C.

6. A printing ink according to claim 5, wherein the boiling point is from 150 to 350° C.

7. A printing ink according to claim 1, wherein the plasticiser is a sebacate.

8. A printing ink according to claim 7, wherein the sebacate is dibutyl sebacate.

9. A printing ink according to claim 1, wherein the plasticiser is a citrate.

10. A printing ink according to claim 3, in which the plasticiser is a fatty acid or mixture of fatty acids.

11. A printing ink according to claim 10, in which the fatty acid is oleic acid, linseed oil fatty acid or tall oil fatty acid.

12. A method of printing, in which an ink according to claim 1 is printed onto a substrate using an intaglio printing press.

13. A method according to claim 12, in which the ink is wiped from the printing cylinder using a waterwipe process.

14. A method according to claim 12, in which the ink is wiped from the printing cylinder using a paperwipe process.

15. A method according to claim 12, in which, after printing, the ink is cured by energy.

16. A method according to claim 15, in which curing is by electron beam or ultraviolet.

17. A printing ink according to claim 2, wherein the plasticiser is food grade.

18. A printing ink according to claim 2, wherein the plasticiser has a molecular weight of from 100 to 500.

19. A printing ink according to claim 18, wherein said molecular weight is from 150 to 350.

20. A printing ink according to claim 2, wherein the plasticiser has a boiling point of from 100 to 500° C.
